(19) United States
(12) Patent Application Publication
(10) Pub. No.: US 2009/0098659 A1
(43) Pub. Date: Apr. 16, 2009

(54) METHOD OF PATTERNING PARTICLES ON AN ARBITRARY SUBSTRATE AND CONDUCTING A MICROFLUIDIC INVASION ASSAY

(76) Inventors: Vinay V. Abhyankar, Philadelphia, PA (US); David J. Beebe, Monona, WI (US)

Correspondence Address: BOYLE FREDRICKSON S.C., 840 North Plankinton Avenue, MILWAUKEE, WI, 53203, US

(21) Appl. No.: 11/870,754

(22) Filed: Oct. 11, 2007

(51) Int. Cl. G01N 1/10; B05D 7/22

(52) U.S. Cl. 436/180; 427/230

(57) ABSTRACT

A method is provided for sequentially patterning different particle populations on spatially defined regions in microfluidic device. The microfluidic device has a channel and a plurality of access ports therein. Each access port has an input and an output communicating with the channel. The method includes the step of depositing a drop of a first suspension on the input of a first access port. The first suspension includes a plurality of particles. A drop of a second suspension is deposited on the input of a second access port. The second suspension includes a plurality of particles. The particles in the first and second suspensions settle onto and are patterned along corresponding spaced portions of the channel.

### FIELD OF THE INVENTION

This invention relates generally to microfluidics, and in particular, to method for patterning particles on an arbitrary substrate and/or to a method for conducting a real-time quantitative investigation of cell invasion/migration in response to a predictable gradient.

### BACKGROUND AND SUMMARY OF THE INVENTION

The in vivo environment is a complex, yet structured system, wherein cellular positioning is highly regulated and soluble factor signaling plays an important role in maintaining, or inducing, appropriate cellular responses. Microfluidic systems provide excellent platforms for studying biological interactions because these systems provide precise control over both exogenous cues and cellular positioning in a culture. The predictability and control over cellular scale domain interrogations, plug flow pulse treatments, and concentration/temperature gradients have facilitated quantitative correlations between environmental factors and resulting cellular responses.

The ability to control the position of cells (spatial micropattening) in a culture is particularly useful because it allows physiologically relevant cells to be cultured together in an organized fashion in vitro in an attempt to recapitulate the in vivo behavior of the target cell population. Organizational control over a culture also provides a convenient way to investigate cell to cell communication; the separation distance between cell populations can be used to probe the degree of soluble factor interactions. The importance of spatial micropatterning in biological assays has led to the development of numerous techniques that effectively position cells in a culture. The most common techniques include microcontact printing and stencil based methods.

Microcontact printing transfers a desired film onto a surface using a pre-coated, geometrically defined polymeric stamp. Complex patterns can be created by strategically positioning both adhesion promoting and limiting regions onto the patterning surface. Stencil-based methods rely on physical, rather than chemical, means to define pattern cells. A polymeric membrane having defined through holes is applied to the patterning surface and physically prevents cells from attaching anywhere other than the areas defined by the through holes. Hence, the location and geometry of adherent cell patterns on the surface is defined by the size and location of the through holes in the stencil. Adjacently placed micro channels can similarly be used to pattern cells; the geometry of the patterned regions is defined by the channel width and the separation distance between the cell populations is defined by the distance between the microchannels. The addition of microfluidic functionality to an organized culture requires the alignment of microchannels over the patterned regions.

While precise control over environmental cues and cellular positioning represents a distinct organizational improvement over traditional culture techniques, current methods cannot add new cell populations to an exciting culture while maintaining overall spatial resolution. Without this capability, temporal aspects of signaling between cell populations cannot be isolated from the behavior of the culture as a whole. That is, in a co-culture assay containing multiple cell types, an observed response in the target population can only be attributed to the presence of the peripheral cell types. It is not possible to investigate the effect of sequential addition of different cell populations into spatially defined regions in the culture. The ability to sequentially add cells to a culture would provide another set of variables to investigate the effects of soluble factor signaling on cellular responses.

In addition to controlling the position of cells in a culture, it is also particularly useful to determine the migratory characteristics of a particular cell type. Heretofore, transwell or cell invasion assays have been used to determine these migratory characteristics. In a typical transwell assay, removable porous filter inserts are coated with an appropriate matrix, e.g., polymerizable gel or collagen, and cells are seeded on top of the coating. A well of a well plate assay is filled with a desired chemical factor and the filter is inserted into the well. Thereafter, the number of cells that invade the matrix and enter the well in response to the chemical factor are counted. The results are compared to genetically modified cells to determine the effect that a particular protein or gene has on migratory behavior. It can be appreciated that the transwell setup is an endpoint assay since it is not possible to make quantitative correlation between cell behavior and the chemical environment present. Consequently, obtaining useful information about the characteristic behavior of cells in response to a chemical gradient (e.g. minimum sensitivity, migration speed, and threshold concentration) before or after invasion is not possible with this type of assay.

Therefore, it is a primary object and feature of the present invention to provide a method for patterning particles on an arbitrary substrate.

It is a further object and feature of the present invention to provide a method for patterning particles on an arbitrary substrate that allows for the sequential addition of different particle populations into spatially defined regions on the substrate.

It is a still further object and feature of the present invention to provide a method for conducting a real-time quantitative investigation of cell invasion/migration in response to a predictable gradient.

In accordance with the present invention, a method is provided for patterning particles in microfluidic device. The microfluidic device includes an upper surface. The method includes the step of providing a channel in the microfluidic device. The channel is partially defined by a lower surface. A plurality of access ports are provided in the microfluidic device. The access ports have a first end communicating with the upper surface of the microfluidic device and a second end communication with the channel. A first suspension including particles is deposited on the first end of a first access port of the plurality of access ports. The particles in the first suspension settle onto and are patterned along a first portion of the lower surface in axially alignment with the second end of the first access port.

A second suspension including particles may be deposited on the first end of a second access port of the plurality of access ports at a user selected time period after the step of depositing the first suspension. The particles in the second suspension settle onto and are patterned along a second portion of the lower surface in axially alignment with the second end of the second access port.

A porous membrane is positioned at the second end of a second access port of the plurality of access ports. Particles are deposited on the porous membrane. The particles diffuse through the porous membrane into the channel and create a gradient in the channel.

The channel and the plurality of access ports may be filled with a first fluid or the channel may be filled with a polymerizable gel and the plurality of access ports may be filled with a first fluid. In addition, a layer of user selected particles may be patterned on the lower surface of the channel prior to the step of depositing the first suspension. In addition, the first end of the first access port defines an input port. The input port may have a polygonal shape.

In accordance with a further aspect of the present invention, a method is provided for patterning particles in microfluidic device. The method includes the step of providing a channel in the microfluidic device. The channel partially defines by a lower surface. A first access port is provided in the microfluidic device. The first access port has an input and an output communicating with the channel. A first drop of a first suspension is deposited on the input of the first access port. The first suspension includes a plurality of particles. The particles in the first suspension settle onto and are patterned along a first portion of the lower surface.

A second access port may be provided in the microfluidic device. The second access port has an input and an output communicating with the channel. A first drop of a second suspension is deposited on the input of the second access port. The second suspension includes a plurality of particles. The particles in the second suspension settle onto and are patterned along a second portion of the lower surface.

A porous membrane may be positioned at the output of a second access port. Particles may be deposited on the porous membrane. The particles diffuse through the porous membrane into the channel and create a gradient in the channel.

The channel and the plurality of access ports may be filled with a first fluid or the channel may be filled with a polymerizable gel and the plurality of access ports may be filled with a first fluid. In addition, the first end of the first access port defines an input port. The input port may have a polygonal shape.

In accordance with a still further aspect of the present invention, a method is provided for patterning particles in microfluidic device. The microfluidic device has a channel and first and second access ports therein. Each access port has an input and an output communicating with the channel. The method includes the step of depositing a drop of a first suspension on the input of the first access port. The first suspension includes a plurality of particles. A drop of a second suspension is deposited on the input of the second access port. The second suspension includes a plurality of particles. The particles in the first suspension settle onto and are patterned along a first portion of a lower surface of the channel.

The particles in the second suspension may settle onto and are patterned along a second portion of the lower surface. The step of depositing the drop of the second suspension on the input of the second access port is temporally spaced from the step of depositing the drop of the first suspension on the input of the first access port. In addition, the method may include the additional step of positioning a porous membrane at the output of a second access port. The particles in the second suspension diffuse through the porous membrane into the channel and create a gradient in the channel.

The channel and the plurality of access ports may be filled with a first fluid or the channel may be filled with a polymerizable gel and the plurality of access ports may be filled with a first fluid. In addition, a layer of user selected particles may be patterned on the lower surface of the channel prior to the step of depositing the drop of the first suspension. Further, the first end of the first access port defines an input port. The input port may have a polygonal shape.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is an isometric view of an exemplary device for effectuating a methodology in accordance with the present invention;

FIG. 2 is an exploded, cross-sectional view of the device of FIG. 1;

FIG. 3 is a cross-sectional view of the device taken along line 3-3 of FIG. 1;

FIG. 4 is an enlarged view of the device taken along line 4-4 of FIG. 3;

FIG. 5 is a top plan view of various alternate embodiments of the input ports for the exemplary device for effectuating a methodology in accordance with the present invention;

FIG. 6 is a cross-sectional view an alternate embodiment of an exemplary device for effectuating a methodology in accordance with the present invention;

FIG. 7A is a cross-sectional view of the device taken along line 7A-7A of FIG. 6;

FIG. 7B is a cross-sectional view of the device, similar to FIG. 7A, showing the device after a predetermined time period;

FIG. 8 is a cross-sectional view of the device taken along line 8-8 of FIG. 6;

FIG. 9 is a cross-sectional view a still further embodiment of an exemplary device for effectuating a methodology in accordance with the present invention; and

FIG. 10 is an enlarged view of the device taken along line 10-10 of FIG. 9.

### BRIEF DESCRIPTION OF THE DRAWINGS

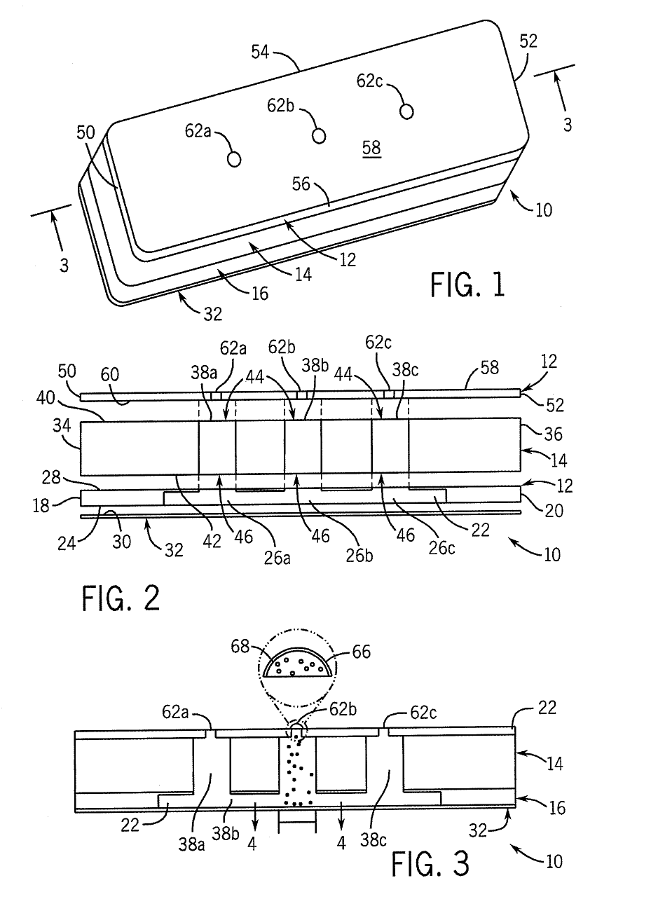

Referring to FIGS. 1-4, a microfluidic device for effectuating the methodology of the present invention is generally designated by the reference numeral 10. It can be appreciated that microfluidic device 10 can have various configurations without deviating from the scope of the present invention. In the contemplated embodiment, microfluidic device 10 is fabricated from (poly)dimethylsiloxane (PDMS) using soft lithography and rapid prototyping. However, microfluidic device may be fabricated from other materials using other manufacturing techniques.

Microfluidic device 10 includes input port layer 12, microwell reservoir layer 14 and assay channel layer 16. In a depicted embodiment, assay channel layer 16 has a generally rectangular configuration and is defined by first and second sides and first and second ends 18 and 20, respectively. Channel 22 is provided in lower surface 24 of assay channel layer 16 and extends along a longitudinal axis. Ports 26a-26c intersect upper surface 28 of assay channel layer 18 and communicate with channel 22. As best seen in FIGS. 2 and 3, ports 26a-26c are longitudinally spaced along channel 22 and upper surface 28 of assay channel layer 16. It is intended for lower surface 24 of assay channel layer 16 to be positioned on upper surface 30 of a substrate 32, e.g., a microscope slide or the like, such that a portion 30a of upper surface 30 of substrate 32 partially defines channel 22.

Similar to assay channel layer 16, microwell reservoir layer 14 has a generally rectangular configuration as defined by first and second sides and first and second ends 34 and 36, respectively. Microwells 38a-38c extend axially between upper and lower surfaces 40 and 42, respectively, of microwell reservoir layer 14 such that upper ends 44 of microwells 38a-38c communicate with upper surface 40 of microwell reservoir layer 14 and such that lower ends 46 of microwells 38a-38c communicate with lower surface 42 of microwell reservoir layer 14. Microwells 38a-38c have cross-sectional dimensions generally equal to the cross-section dimensions of ports 26a-26c in assay channel layer 16. Lower surface 42 of microwell reservoir layer 14 is positioned on upper surface 28 of assay channel 16 such that first and second ends 34 and 36, respectively, of microwell reservoir layer 14 are axially aligned with corresponding first and second ends 18 and 20, respectively, of assay channel layer 16, and such that second ends 46 of microwells 38a-38c through microwell reservoir layer 14 are in registry with and communicate with ports 26a-26c in assay channel layer 16.

Input port layer 12 is defined by first and second ends 50 and 52, respectively, and first and second sides 54 and 56, respectively. Input port layer 12 further includes upper surface 58 and lower surface 60 interconnected to upper surface 40 of microwell reservoir layer 14. Input port layer 12 is positioned on upper surface 40 of microwell reservoir layer 14 such that first and second ends 50 and 52, respectively, of input port layer 12 are aligned with corresponding first and second ends 34 and 36, respectively, of microwell reservoir layer 14. Input port layer 12 further includes a plurality of longitudinally spaced input ports 62a-62c. It is intended for input ports 62a-62c to extend between upper surface 58 and lower surface 60 of input port layer 12. It is further intended for input ports 62a-62c through input port layer 12 to communicate with corresponding microwells 38a-38c through microwell reservoir layer 14.

As best seen in FIG. 1, input ports 62a-62c through input port layer 12 may have generally circular configurations. However, other configurations are contemplated as being within the scope of the present invention. Referring to FIG. 5, various alternate configurations for the input ports through input port layer 12 are depicted. For example, input port 64a has a generally square configuration. Input port 64b has a triangular configuration. Input port 64c has a generally oval configuration. Input port 64d has a generally clover shaped configuration. The sizes and shapes of the input ports through input port layer 12 correspond to the desired cellular patterning in channel 22, as hereinafter described.

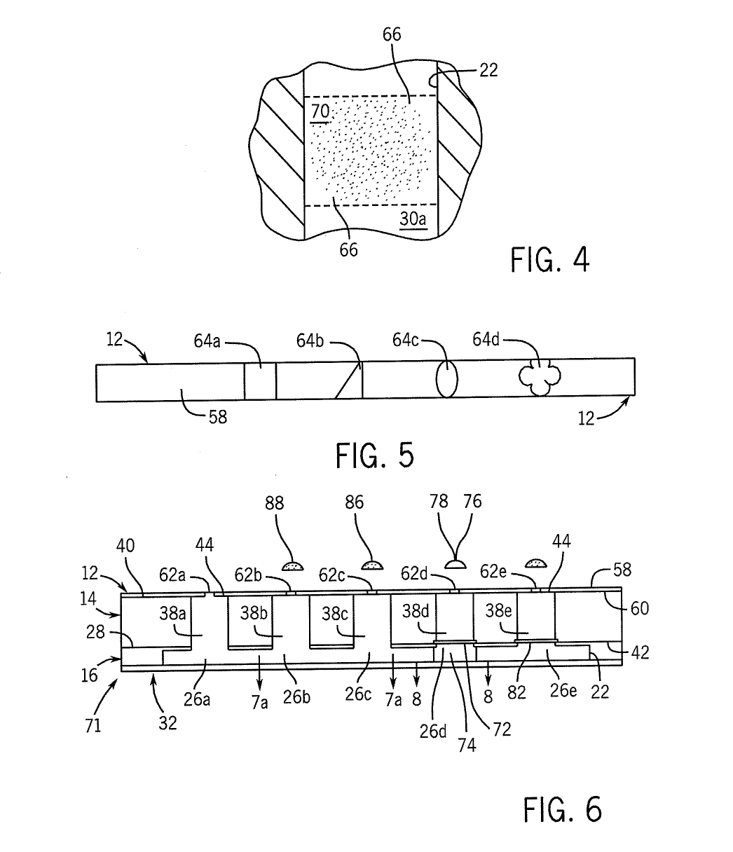

In operation, channel 22, microwells 38a-38c and input ports 62a-62c are filled with a user desired solution. A suspension having a plurality of predetermined particles 66, e.g. cells, is prepared and a small volume drop 68 of the suspension is placed on a user selected input port, e.g., input port 62b, through input port layer 12. Drop 68 makes fluid contact with the fluid in microwell 38b such that the particles 66 in drop 68 begin to settle and pass through microwell 38b into channel 22. The geometry of the user selected input port and the corresponding microwell limits the region wherein the particles are able to enter channel 22. As a result, as best seen in FIG. 4, the particles 66 settle on and adhere to portion 70 of upper surface 30 of substrate 32. Portion 70 of upper surface 30 of substrate 32 is axially aligned with corresponding microwell 38b. It is noted that by changing the configuration of input ports 62a-62c to one of the configurations of input ports 64a-64d, as heretofore described, the geometric patterns of the particles patterned on portion 70 of upper surface 30 of substrate 32 may be altered.

It can be appreciated that a second drop of the same or different particle suspension may be deposited on one of the other input ports, e.g., input ports 62a and 62c, a predetermined time period after the patterning of particles 66 on portion 70 of upper surface 30 of substrate 32. The second drop makes fluid contact with the fluid in the corresponding microwell 38a, 38c such that the particles in the second drop begin to settle and pass through the corresponding microwell 38a, 38c into channel 22. The particles of the second drop settle on and adhere to a second portion of upper surface 30 of substrate 32 that is axially aligned with the corresponding microwell 38a, 38c. As a result, it can be appreciated that the method presented herein allows for the patterning of single particle suspensions for multi-cellular cell colonies onto arbitrary patterning substrates with both spatial and temporal resolution.

In the alternative, it is contemplated to pattern a predetermined layer of particles on upper surface 30 of substrate 32 prior to assembling microfluidic device 10. As a result, it can be appreciated that the method of the present invention allows for the patterning of particles 66 on a preexisting layer of particles patterned on upper surface 30 of substrate 32. In addition, it is contemplated to fill channel 22 with a polymerizable gel prior to the filling of microwells 38a-38c with a user selected fluid. The polymerizable gel creates a three-dimensional substrate. As a result, when drop 68 is deposited on input port 62b, as heretofore described, particles 66 flow through input port 68b and microwell 38b so as to pattern on the polymerizable gel substrate. Additional particles may be spatial temporally patterned on the polymerizable gel substrate, as heretofore described.

Further, after patterning particles 66 on portion 70 of upper surface 30 of substrate 32, it is contemplated to deposited a drop of a second suspension on input port 62b such that the drop of the second suspension makes fluid contact with the fluid in microwell 38b. Thereafter, the particles of the second suspension begin to settle and pass through microwell 38b into channel 22. The particles of the second suspension settle on and adhere to the particles 66 previously patterned on portion 70 of upper surface 30 of substrate 32, as heretofore described.

Referring to FIG. 6, an alternate embodiment of a microfluidic device for effectuating the methodology of the present invention is generally designated by the reference numeral 71. Except as hereinafter provided, microfluidic device 71 is identical to microfluidic device 10. As such, the common reference numerals are used to identify common elements in both microfluidic device 70 and microfluidic device 10.

In addition to input ports 62a-62c, input port layer 12 of microfluidic device 71 further includes a plurality of longitudinally spaced input ports 62d-62e. It is intended for input ports 62d-62e to extend between upper surface 58 and lower surface 60 of input port layer 12. It is further intended for input ports 62d-62e through input port layer 12 to communicate with corresponding microwells 38d-38e through microwell reservoir layer 14. Input ports 62d-62e through input port layer 12 may have generally circular configurations, but the other configurations heretofore described with respect to microfluidic device 10 are contemplated as being within the scope of the present invention.

Microwells 38d-38e extend axially between upper and lower surfaces 40 and 42, respectively, of microwell reservoir layer 14 such that upper ends 44 of microwells 38d-38e communicate with corresponding input ports 62d-62e through input port layer 12. Second ends 46 of microwells 38d-38e through microwell reservoir layer 14 are in registry with and adjacent to ports 26d-26e in assay channel layer 16. Microwells 38d-38e have cross-sectional dimensions generally equal to the cross-section dimensions of ports 26d-26e in assay channel layer 16. Ports 26d-26e intersect upper surface 28 of assay channel layer 16 and communicate with channel 22.

First porous membrane 72 is positioned between lower surface 42 of microwell reservoir layer 14 and upper surface 28 of assay channel layer 16 so as to overlap port 26d. First porous membrane 72 increases the fluidic resistance of the system and a source for an exogenous stimulus. More specifically, referring to FIGS. 6 and 8, gradient 74 of exogenous factor 76 may be created in channel 22 filling channel 22 and input ports 62a-62e with a user selected solution. A suspension of the exogenous factor 76 (e.g., chemical stimuli or fixing and lysing agents) is prepared and a small volume drop 78 of the suspension is deposited on input port 62d, through input port layer 12. Drop 78 makes fluid contact with the fluid in microwell 38d such that exogenous factor 76 in drop 78 begin to settle and pass through microwell 38d such that exogenous factor 76 settles on the upper surface of first porous membrane 72. Exogenous factor 76 diffuses through first porous membrane 72 and into channel 22, thereby forming gradient 74, FIG. 8.

Second porous membrane 82 is positioned between lower surface 42 of microwell reservoir layer 14 and upper surface 28 of assay channel layer 16 so as to overlap port 26e. As such, drop 84 of non-adherent or suspension-cultured particles having diameters less than the pore diameter of second porous membrane 82 may be introduced into microwell 38e though input port 62e. The non-adherent or suspension cultured particles diffuse through the second porous membrane 82 so as to present signaling factors to particles 66 patterned in channel 22, as hereinafter described.

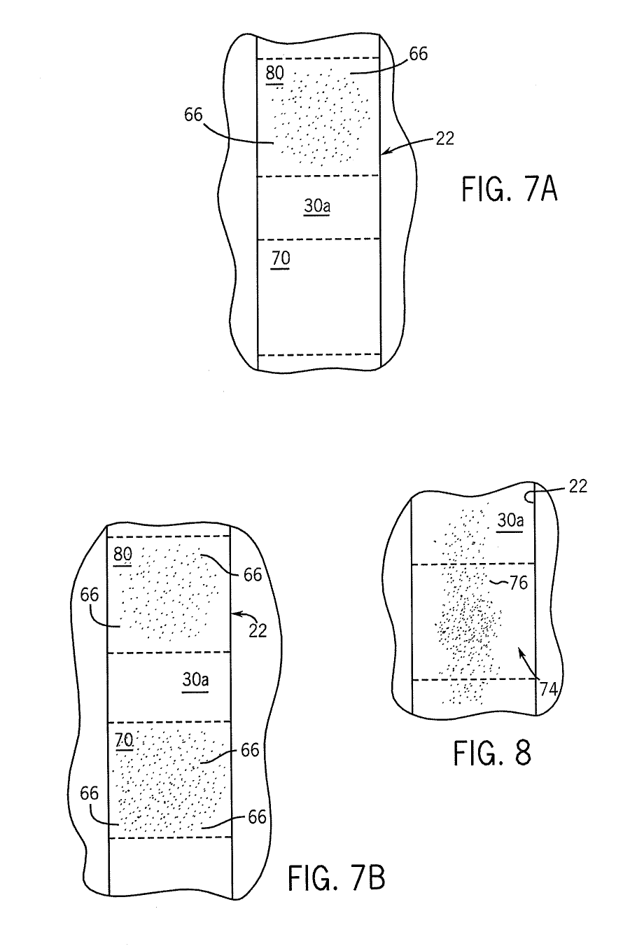

Once gradient 74 is created, small volume drop 86 of the suspension of particles 66 is placed on a user selected input port, e.g., input port 62c, through input port layer 12. Drop 86 makes fluid contact with the fluid in microwell 38c such that the particles 66 in drop 86 begin to settle and pass through microwell 38c into channel 22. As best seen in FIG. 7A, particles 66 settle on and adhere to portion 80 of upper surface 30 of substrate 32. Portion 80 of upper surface 30 of substrate 32 is axially aligned with corresponding microwell 38c. It can be appreciated that the patterned particles 66 on upper surface 30 of substrate 32 are exposed to gradient 74.

Thereafter, second drop 88 of the particle suspension may be deposited on a desired input port, e.g. input port 62b, a predetermined time period after the patterning of particles 66 on portion 80 of upper surface 30 of substrate 32. Second drop 88 makes fluid contact with the fluid in the corresponding microwell 38b such that particles 66 in second drop 88 begin to settle and pass through the corresponding microwell 38b into channel 22. The particles 66 of the second drop settle on and adhere to portion 70 of upper surface 30 of substrate 32 that is axially aligned with the corresponding microwell 38b, FIG. 7B. As a result, it can be appreciated that the method presented herein allows for the patterning of single particle suspensions for multi-cellular cell colonies onto arbitrary patterning substrates with both spatial and temporal resolution.

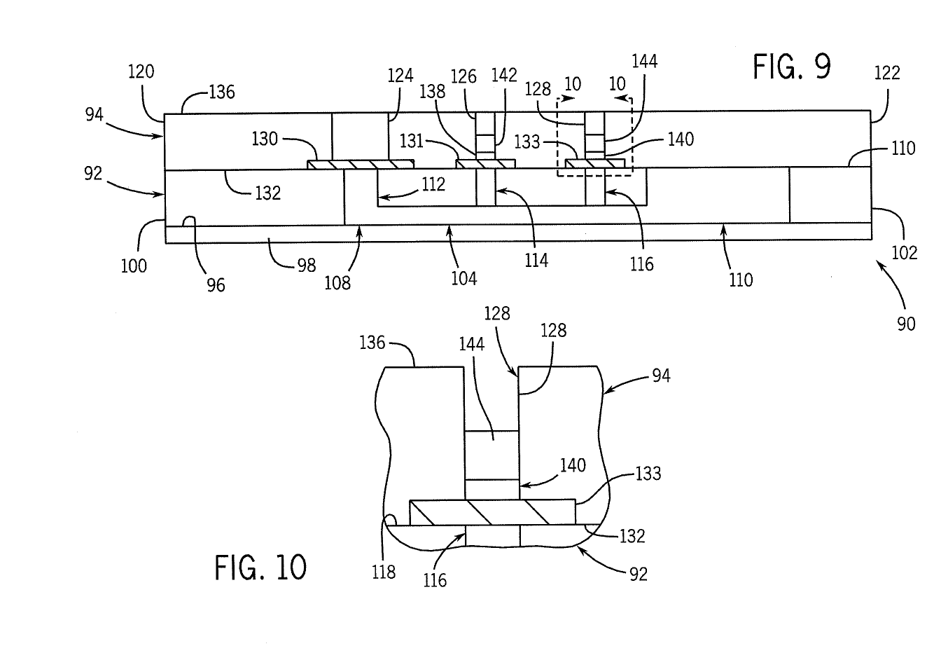

Referring to FIGS. 9-10, a still further alternate embodiment of a device for effectuating the methodology of the present invention is generally designated by the reference numeral 90. Microfluidic device 90 includes bottom channel layer 92 and upper layer 94. Bottom channel layer 92 positioned on upper surface 96 of microscope slide 98 or other similar substrate, without deviating from the scope of the present invention. In the depicted embodiment, bottom channel layer 92 is defined by first and second sides and first and second ends 100 and 102, respectively. Channel 104 is provided in lower surface 106 of bottom channel layer 92 and extends along a longitudinal axis between source region 108 and enlarged sink region 110. Access ports 112, 114 and 116 are punched in upper surface 118 of bottom channel layer 92, respectively, with a sharpened coring tool or the like. It is intended for access port 112 to communicate with source region 108. For reasons hereinafter described, sink region 110 in lower surface 106 of bottom channel layer 92 has a diameter greater than the diameter of source region 108.

Similar to bottom channel layer 92, upper layer 94 is defined by first and second sides and first and second ends 120 and 122, respectively. Access ports 124, 126 and 128 are punched through upper layer 94 with a sharpened coring tool or the like. In order to assemble microfluidic device 90, access port 112 of the bottom channel layer 92 is covered with membrane 130 having pores therethrough of a predetermined diameter (e.g., 0.2 micrometers). Similarly, access ports 114 and 116 of the bottom channel layer 92 are covered with corresponding membranes 131 and 133 having pores therethrough of a predetermined diameter. Thereafter, lower surface 132 of upper layer 94 is positioned on upper surface 118 of bottom channel layer 92 such that the first and second sides of upper layer 94 are aligned with corresponding first and second sides, respectively, of bottom channel layer 92 and such that first and second ends 120 and 122, respectively, of upper layer 94 are aligned with first and second ends 100 and 102, respectively, of bottom channel layer 92. Bottom channel layer 92 and upper layer 94 are permanently bonded together using oxygen plasma treatment. With microfluidic device 90 assembled, membranes 130, 131 and 133 are sandwiched in between bottom channel layer 92 and upper layer 94 and provide porous barriers between access ports 124, 126 and 128 through upper layer 94 and corresponding access ports 112, 114 and 116 in bottom channel layer 92.

In operation, collagen layers or polymerizable gels 138 and 140 are deposited on the upper surfaces of membranes 131 and 133, respectively. It can be appreciated the polymerizabale gels 138 and 140 may be fabricated from layers of different types of gels. As such, it is contemplated for one or more of the layers polymerizabale gels 138 and 140 maybe used to replace membranes 131 and 133. Access ports 112, 114 and 116 in bottom channel layer 92; access port 124 in upper layer 92; channel 104 in bottom channel layer 92; source region 108 in bottom channel layer 92 and sink region 110 in bottom channel layer 92 are filled with a first predetermined solution, such as deionized water. A predetermined fluid having a known concentration of particles, such as cells, molecules, chemical species, organisms or the like, therein are introduced or loaded into microfluidic device 90 through access port 124 in upper layer 94. A glass cover slip may be placed on upper surface 136 of top fluid reservoir layer 16 so as to overlap and seal corresponding access port 124 to prevent evaporation of the predetermined fluid.

Diffusive transport of the predetermined fluid is allowed through membrane 130 while the fluidic resistance of membrane 130 minimizes the convective flows in channel 104. As a result, the predetermined fluid diffuses through membrane 130 and into channel 104 creating a concentration gradient of particles from source region 108 to sink region 110 over a predetermined time period.

Once the gradient is established in channel 104, cells or particles 142 and 144 are deposited on corresponding polymerizable gels 138 and 140. Particles 142 and 144 sense the gradient, invade corresponding polymerizable gels 138 and 140, and enter channel 104 in response to gradient. It is contemplated to track particles 138 and 140 after migration of particles 138 and 140 into channel 104. As such, a user can sort migratory from non-migratory particles. In addition, microfluidic device 90 may be used to determined gradients of factors that maximally inhibit invasion or limit migration of particles 138 and 140. The methodology heretofore described provides information about metastatic cell characteristics (e.g., minimum stimulus sensitivity or “optimal” gradients that lead to maximum speed or percent invasion of particles 142 and 144) that is not possible using prior methods.

Various alternatives are contemplated as being within the following claims particularly pointing out and distinctly claiming the subject matter regarded as the invention.

We claim:

1. A method of patterning particles in microfluidic device, the microfluidic device including an upper surface, the method comprising the steps of:
providing a channel in the microfluidic device, the channel partially defined by a lower surface;
providing a plurality of access ports in the microfluidic device, the access ports having a first end communicating with the upper surface of the microfluidic device and a second end communication with the channel; and
depositing a first suspension including particles on the first end of a first access port of the plurality of access ports;
wherein particles in the first suspension settle into and are patterned along a first portion of the channel in axial alignment with the second end of the first access port.

2. The method of claim 1 comprising the additional step of depositing a second suspension including particles on the first end of a second access port of the plurality of access ports at a user selected time period after the step of depositing the first suspension, the particles in the second suspension settling onto and being patterned along a second portion of the channel in axial alignment with the second end of the second access port.

3. The method of claim 1 comprising the additional step of positioning a porous membrane at the second end of a second access port of the plurality of access ports.

4. The method of claim 3 comprising the additional step of depositing particles on the porous membrane, the particles diffusing through the porous membrane into the channel and creating a gradient in the channel.

5. The method of claim 1 comprising the additional step generating a gradient in the channel of the microfluidic device.

6. The method of claim 1 comprising the additional step of filling the channel and the plurality of access ports with a first fluid.

7. The method of claim 1 comprising the additional step of filling the channel with a polymerizable gel and the plurality of access ports with a first fluid.

8. The method of claim 1 wherein the first end of the first access port defines an input port, the input port having a polygonal shape.

9. The method of claim 1 comprising the additional step of depositing a first drop of a second suspension on the input of the first access port, the second suspension including a plurality of particles.

10. A method of patterning particles in microfluidic device, the method comprising the steps of:
providing a channel in the microfluidic device, the channel partially defined by a lower surface;
providing a first access port in the microfluidic device, the first access port having an input and an output communicating with the channel; and
depositing a first drop of a first suspension on the input of the first access port, the first suspension including a plurality of particles;
wherein particles in the first suspension settle onto and are patterned along a first portion of the channel.

11. The method of claim 10 comprising the additional steps:
providing a second access port in the microfluidic device, the second access port having an input and an output communicating with the channel; and
depositing a first drop of a second suspension on the input of the second access port, the second suspension including a plurality of particles;
wherein particles in the second suspension settle onto and are patterned along a second portion of the channel.

12. The method of claim 11 comprising the additional step of positioning a porous membrane at the output of a second access port.

13. The method of claim 12 comprising the additional step of depositing particles on the porous membrane, the particles diffusing through the porous membrane into the channel and creating a gradient in the channel.

14. The method of claim 10 comprising the additional step generating a gradient in the channel of the microfluidic device.

15. The method of claim 10 comprising the additional step of filling the channel with a polymerizable gel.

16. The method of claim 10 wherein the input has a polygonal shape.

17. A method of patterning particles in microfluidic device, the microfluidic device having a channel and first and second access ports therein, each access port having an input and an output communicating with the channel, the method comprising the steps of:
depositing a drop of a first suspension on the input of the first access port, the first suspension including a plurality of particles;
depositing a drop of a second suspension on the input of the second access port, the second suspension including a plurality of particles;
wherein particles in the first suspension settle onto and are patterned along a first portion of the channel.

18. The method of claim 17 wherein particles in the second suspension settle onto and are patterned along a second portion of the channel.

19. The method of claim 17 wherein the step of depositing the drop of the second suspension on the input of the second access port is temporally spaced from the step of depositing the drop of the first suspension on the input of the first access port.

20. The method of claim 17 comprising the additional step of positioning a porous membrane at the output of a second access port, the particles in the second suspension diffusing through the porous membrane into the channel and creating a gradient in the channel.

21. The method of claim 17 comprising the additional step generating a gradient in the channel of the microfluidic device.

22. The method of claim 17 comprising the additional step of filling the channel with a polymerizable gel.

23. The method of claim 17 wherein each input has a polygonal shape.

24. The method of claim 17 comprising the additional step of patterning a layer of user selected particles on a lower surface of the channel prior to the step of depositing the drop of the first suspension.

25. A method for conducting a cell migration assay in a microfluidic device, the microfluidic device including a channel having a plurality of access ports communicating therewith, the method comprising the steps of:
generating a gradient in the channel;
providing a first porous membrane between a first access port and the channel;
providing a second porous membrane between a second access port and the channel;
depositing a polymerizable gel on a first side of the first porous membrane;
depositing the polymerizable gel on a first side of the second porous membrane;
depositing a first cell population on the polymerizable gel on the first side of the first porous membrane;
depositing a second cell population on the polymerizable gel on the first side of the second porous membrane; and
observing the first and second cell populations.
